(19) United States
(12) Patent Application Publication
(10) Pub. No.: US 2017/0302741 A1
(43) Pub. Date: Oct. 19, 2017

(54) SYSTEMS AND METHODS FOR PROCESS MONITORING AND CONTROL

(71) Applicant: ARK-LA-TEX Remote Monitoring and Control, LLC, Benton, LA (US)

(72) Inventor: Donald Ross Conner, El Dorado, AR (US)

(21) Appl. No.: 15/349,986

(22) Filed: Nov. 11, 2016

Related U.S. Application Data
(60) Provisional application No. 62/253,984, filed on Nov. 11, 2015.

(51) Int. Cl. H04L 29/08; H04Q 9/00; G08B 23/00; H04W 84/06; H04W 84/04

(52) U.S. Cl. CPC H04L 67/125; H04Q 9/00; H04L 67/02; G08B 23/00; H04L 67/10; H04Q 2209/40; H04W 84/042; H04W 84/06

(57) ABSTRACT

Methods and systems for monitoring and control of remote processes are provided herein. The methods comprise communications over a cellular or satellite network, and monitoring and control of multiple processes over vast distances. The systems feature a physical or virtual controller connected to and accessible via the Internet. An Internet-accessible user dashboard is also provided.

### CROSS-REFERENCE TO RELATED APPLICATIONS

This claims benefit of U.S. Provisional Patent Application No. 62/ 253,984, filed Nov. 11, 2015, the entirety of which is incorporated by reference herein.

### BACKGROUND

### Field of the Invention

This relates generally to systems and methods for monitoring and controlling industrial processes over remote networks such as satellite and cellular networks. More particularly, this relates to systems and methods for monitoring and control of remote installations, including unmanned and remote installations using cellular and satellite networks.

### Description of Related Art

Systems for monitoring and controlling processes such as industrial processes generally comprise continuous, intermittent, or discreet measurement of one or more process parameters, and comparison of the measured value with a desired value, set value, or the like. Complex central control systems in the past generally utilized numerous pneumatic actuators that required expensive installation and extensive maintenance. Modern systems are comparatively easier to set up and maintain, and can provide control over greater distances. Typically, in more modern systems, a programmable logic controller (a ‘PLC’) or similar device is used to implement the monitoring and control. The PLC comprises various inputs and output and is able to read (i.e. interpret) one or more measurements or inputs (from sensors and similar input devices), apply a set of logic statements and rules based on those inputs, and then generate one or more outputs in accordance with the logic statements and rules it has been programmed with. The typical process control system thus encompasses the process equipment, a plurality of sensors for providing measurements or inputs, one or more PLCs, a plurality of output-responsive devices for responding to the generated outs from the PLCs. Additional components can include one or more central processing units (CPUs), and PCs, visual displays, and such other devices as may be useful to human process monitors, or operators.

Preferably, the measurements or inputs can be either analog or digital in form, depending on a variety of factors including the nature of the process parameter being measured, the type of device or equipment available to measure the process parameter, whether the measurement is discreet, continuous, or intermittent, the nature of the logic and rules to be applied based on the measurement or input, and the type of end-result to be achieved by the output of the PLC.

The generated outputs can also preferably be either analog or digital in form, depending on a variety of factors. In some cases, the system is only used for monitoring a process, in which case the PLC may merely generate a log of process conditions outside of set parameters, or the PLC output may trigger e.g. an alarm, an alert, or a message to a human operator. In other systems, the process is not only monitored but also controlled, i.e. if a measure parameter is outside of acceptable limits according to the logic of the programming PLC, the generated output is not merely an alert, but a signal to cause a change in the process.

The logic of the PLC can be very simple or very complex depending on the process and the capabilities of the PLC. In a simple case the PLC may only have one possible output in a given circumstance. For example, a measured temperature that is too high means the temperature is turned down, by controlling e.g. a thermostat, or even the amount or rate of fuel being provided to the heater. If the temperature is too low, the PLC outputs increases the thermostat, or the amount or rate of fuel provided. In other cases, the logic of the PLC is far more sophisticated than a basic thermostat-like function. For example, if a measured temperature is too high, the PLC output may adjust a thermostat, decrease the flow of fuel, or turn on or increase flow in a cooling device, or take other actions designed to regulate the temperature and restore the system to a temperature within acceptable limits. If a measured pressure is too high, the PLC logic may include options to lower temperature, open a vent or bypass, decrease input flow rate, increase output flow rate, or the like. The logic may include complex factors like the cost of fuel, raw material supplies, the current level of product in the warehouse, product output needed, and the maintenance status (e.g. repair status of equipment, time to next scheduled shutdown, etc.) and the choice of which control measure to implement will be determined based on the logic built/programmed into the PLC; i.e. the PLC executes the instructions provided in its programming.

Traditionally, process monitoring and control were done locally, i.e. the systems required the components (e.g. the equipment being monitored had to be hard-wired to the sensors, receivers, analog to digital converters, PLC, CPUs, and the like). In more recent years, wireless sensors, and other components have been developed for use over networks, such as Ethernet networks, WIFI, LAN, and even various WAN networks. Still more recently, process monitoring systems have been developed that communicate over radio and similar line-of-sight systems. Such systems typically require use of dedicated antennas to transmit signals.

Particularly in industrial scenarios that cover large distances, and in dealing with remote locations and unmanned installations, frequently radio antennas/line-of-sight based network are simply not available, not practical, and/or not economical.

There are presently some examples of consumer products that allow control completely via the Internet over basic devices such as household lights, door locks, alarm systems, and thermostats. While such systems provide interesting functionality for consumers, they do not provide and do not appear capable of the degree of monitoring and control needed for industrial process control, moreover they do not utilize cellular or satellite networks for monitoring or control functions.

In addition to the consumer systems, there are some industrial systems for sending e.g., alarms, alerts, or the like via wireless communications, including cellular communications. There have also been various SCADA systems developed for monitoring and controlling remote processes. Traditionally, SCADA systems have primarily utilized communications such as radio or other antenna-based systems. While these systems are useful for industrial monitoring and control, they have generally required proprietary hardware and utilized proprietary communications protocols to lock in the end-users.

To date, there have been no truly workable systems that enable full industrial monitoring and control over vast distances over available networks capable of supporting such functions, including cellular, and/or satellite systems, or such systems in combination with the Internet.

There is therefore a need for new or improved systems and methods for monitoring and control of industrial processes that allow monitoring and control over large distances and for remote or unmanned locations.

### SUMMARY

Novel systems and methods of monitoring and controlling industrial processes and facilities, including over vast distances, are provided herein. The systems and methods uniquely comprise communications from a process sensor or controller via a cellular (or satellite) network to the Internet (or similar network) and back to a cellular (or satellite) network and to its final destination e.g. a process controller or device.

In a first of its several aspects, this disclosure provides methods for monitoring and controlling an industrial process or an industrial setting using a cellular or satellite network and the Internet or similar network. The methods generally comprise the steps of:
measuring one or more parameters associated with an industrial process or industrial setting with at least one sensor module adapted for measuring the one or more parameters;
sending, via a cellular or satellite network, one or more signals corresponding to the one or more measurements to an electronic controller adapted for receiving and processing the signals;
transmitting the signals from the cellular or satellite network via the Internet or similar network to the electronic controller;
using the electronic controller for receiving and processing the signals using software comprising processing logic and instructions executed by the electronic controller;
generating, using the electronic controller, one or more outputs in response to the signals;
transmitting the one or more outputs to one or more device modules capable of responding to the outputs and adapted for receiving the outputs via a cellular or satellite network; and
executing one or more actions based on the output, on the monitored process or setting or at one or more remote processes or settings.

Generally, the electronic controller is connected to and accessible via the Internet or a similar network. The controller is not wired to or connected directly to the sensors or the devices but rather is in communication with the sensors and devices solely via the cellular or satellite network. The signal and the output of the method are digital, but the parameter measured may be measured in analog, and the output may be converted to an analog signal where useful, for example, where the action requires analog information. Accordingly, both the sensor modules and the device modules may include electronics adapted for converting analog information into digital data and/or vice versa. Moreover, the sensor modules and device modules are adapted for cellular communication directly or indirectly, such as by arranging the sensors in communication with a modem functionality. Preferably, the sensor modules and device modules comprise sensors in communication with a PLC and the PLC directly or indirectly controls and directs the communications. The one or more device modules may be located in one or more remote locations such that monitoring of a site in a first location can result in outputs to generate control actions in that location or in any number of remote locations.

In another of its several aspects, this disclosure provides systems for monitoring and controlling an industrial process or setting. The systems generally comprise:
one or more sensor modules adapted for measuring one or more parameters associated with an industrial process or setting and sending a signal corresponding to the measurement via a cellular or satellite network;
an electronic controller adapted for receiving and processing signals from each of the plurality of sensor modules, generating one or more outputs in response to each signal, and transmitting the outputs;
software adapted for execution by the electronic controller and comprising instructions for processing each signal, and determining what actions to take in response to such signals, generating outputs to accomplish the desired actions, and transmitting the outputs to devices modules at the monitored process or setting, or at one more remote industrial processes or industrial settings; and
a plurality of device modules adapted for receiving the outputs and taking an action in response thereto.

The electronic controller is typically connected to and accessible via the Internet or a similar network. The controller is in communication with the sensor modules and the device modules via the cellular or satellite network but is not physically wired thereto. The signals are sent and the outputs are received via a cellular or satellite network. Intermediate transmission of the signals and outputs can be via the Internet or similar network, i.e. for signals subsequent to being sent and for outputs prior to being received, respectively. The electronic controller is in communication with the sensor modules and the device modules generally. The one or more signals and the one or more outputs comprise analog or digital information and may be sent to or from any location.

Generally, the systems utilize wireless communications using at least a cellular or satellite network. Such communications are used to send the initial and to receive the output. Intermediate transmission can be via the Internet (or similar public or private network comprising e.g. multiple nodes capable of communicating with each other, and using an Internet protocol or other network protocol for sending and receiving data in a consistent and useful manner even where one or more nodes of the network are unable to communicate).

In another aspect, methods are provided for monitoring for and responding to the presence of gas of interest in an industrial process or an industrial setting. In certain embodiments, the gas of interest comprises an unpleasant, harmful, toxic, noxious, explosive or otherwise undesirable gas. The gas measurement may be indicative of a leak, a process concern, a health concern, a threat to life, or other urgent situation. The methods for gas detection generally comprise the steps of:

a) measuring one or more parameters associated with the presence of a gas in an industrial process or industrial setting with at least one sensor adapted for measuring the parameter;

b) reading the measurement with a PLC;

c) sending a signal corresponding to the gas measurement via a cellular or satellite network to an electronic controller adapted for receiving the signal;

d) comparing the signal to a desired value using software comprising processing logic and instruction executed by the electronic controller;

e) determining whether the gas is present at an actionable level based on the signal;

f) generating, using the electronic controller, one or more outputs in response to the signal;

g) transmitting the one or more outputs, via a cellular or satellite network to one or more device modules adapted for receiving the output and taking an action in response thereto; and

h) executing one or more actions based on the output.

In a typical application, the one or more signals and the one or more outputs comprise analog or digital information. Where analog information is detected initially or required for an action, the method can comprise the additional step of using an analog to digital converter or digital to analog converter to convert the information. The device modules may be located at the site of the gas parameter being monitored, and/or at one or more remote site, thus enabling controlling actions to be taken at the local site or multiple remote sites.

In a further aspect of the present disclosure, methods are provided for mitigating the safety, environmental, economic, or legal consequences of an industrial problem or accident. The methods typically comprise the steps of:

a) implementing a system for monitoring and controlling an industrial process or setting comprising:
i) one or more sensor modules adapted for measuring one or more parameters associated with an industrial process or setting and sending a signal corresponding to the measurement via a cellular or satellite network;
ii) an electronic controller adapted for receiving and processing signals from each of the plurality of sensor modules, generating one or more outputs in response to each signal, and transmitting the outputs;
iii) software adapted for execution by the electronic controller and comprising instructions for processing each signal, and determining what actions to take in response to such signals, generating outputs to accomplish the desired actions, and transmitting the outputs to devices modules at the monitored process or setting, or at one more remote industrial processes or industrial settings;
iv) a plurality of device modules adapted for receiving the outputs and taking an action in response thereto; and
v) at least one server for storing information regarding the process, serving the software in a form readable by the controller, and serving a web-based user portal; wherein the server and user portal are accessible from any location via the Internet or similar network;

wherein the electronic controller is in communication with the sensor modules and the device modules at least via the cellular or satellite network; and in communication with the server via the Internet or similar network;

b) employing the system to detect a signal indicative of a potential problem or accident with safety, environmental, economic, or legal consequences;

c) sending outputs via the system for one or more of the following:
i) activating one or more alarms or emergency evacuation systems for any personnel in the vicinity of the problem or accident;
ii) logging useful data in connection to the problem or accident; said data comprising at least the signals corresponding to process measurements;
iii) activating a local or remote system for recording audio and/or visual information related to the problem or accident;
iv) switching on or off, or adjusting a setting in one or more aspects of the industrial process or a remote process; and
v) alerting one or more parties comprising an engineer, a manager, first responders, an executive, a regulatory authority, an emergency department, a health authority, an insurer, a legal advisor, or an investor about the problem;

d) providing access to the logged data to one or more of the parties alerted; and

e) continuing to log available data related to or about the problem or accident.

Systems for practicing the foregoing methods are also provided herein.

These and/or further aspects, features, and advantages of the present invention will become apparent to those skilled in the art in view of this disclosure.

### BRIEF DESCRIPTION OF THE DRAWINGS

FIG. 1: An overview of an industrial monitoring and control system using a cellular or satellite network.

FIG. 2: A flow chart showing showing a generalized embodiment of a method for monitoring and controlling an industrial process or industrial setting, and the flow of communications via the cellular or satellite network, and transmission via the Internet.

FIG. 3: Diagram of an embodiment of a system showing monitoring of a local process or parameters in combination with control of a local and remote process or parameter.

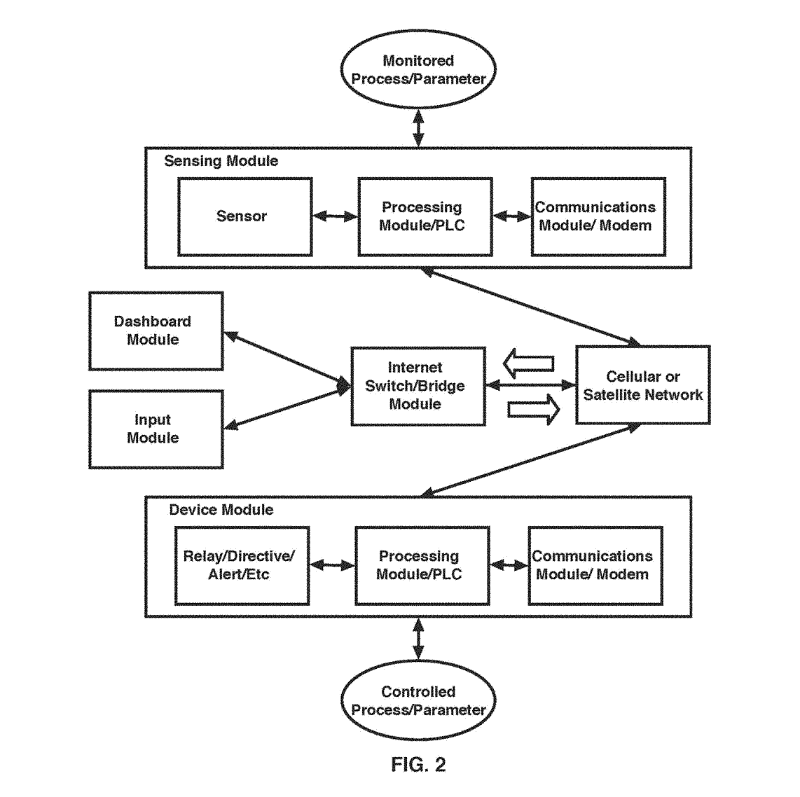

FIG. 2: A diagrammatic representation of a specific embodiment showing a method of gas detection, i.e. monitoring an industrial setting for the presence of an explosive, noxious, hazardous, toxic, or otherwise undesirable gas.

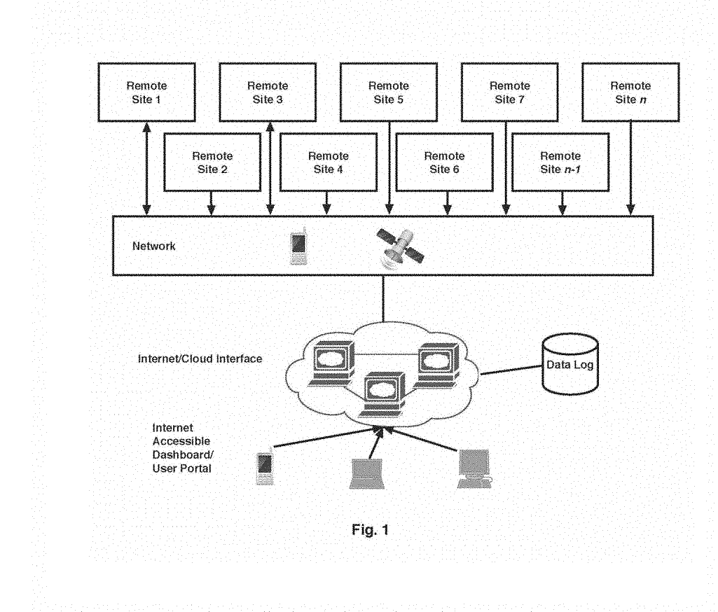

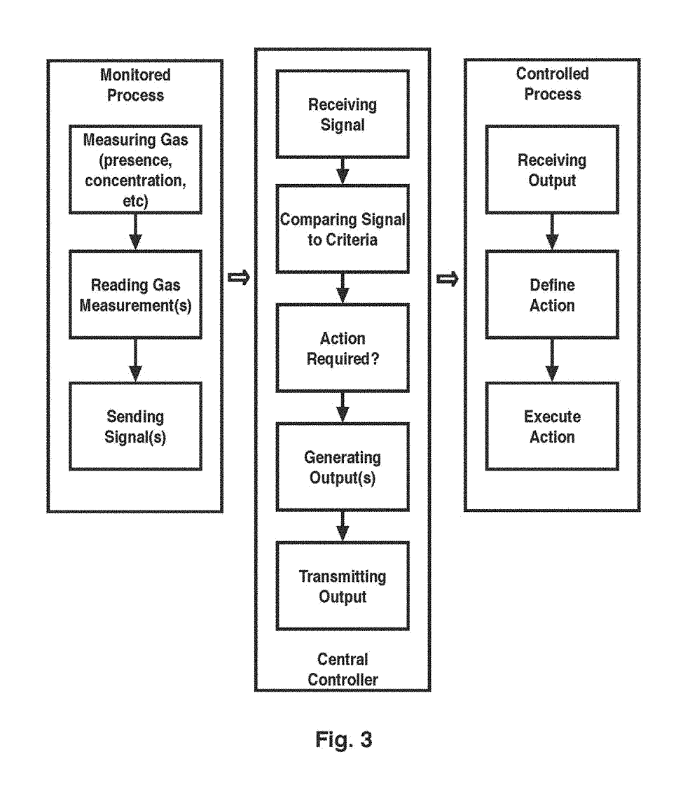

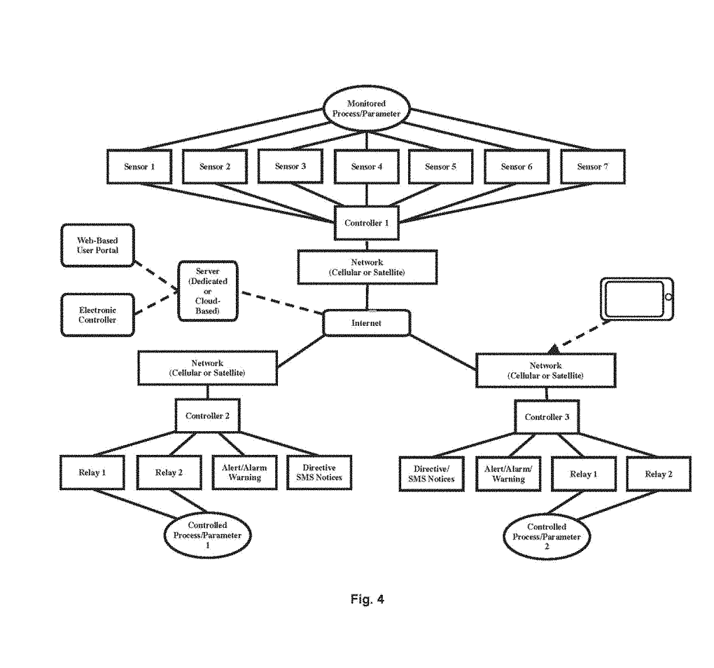

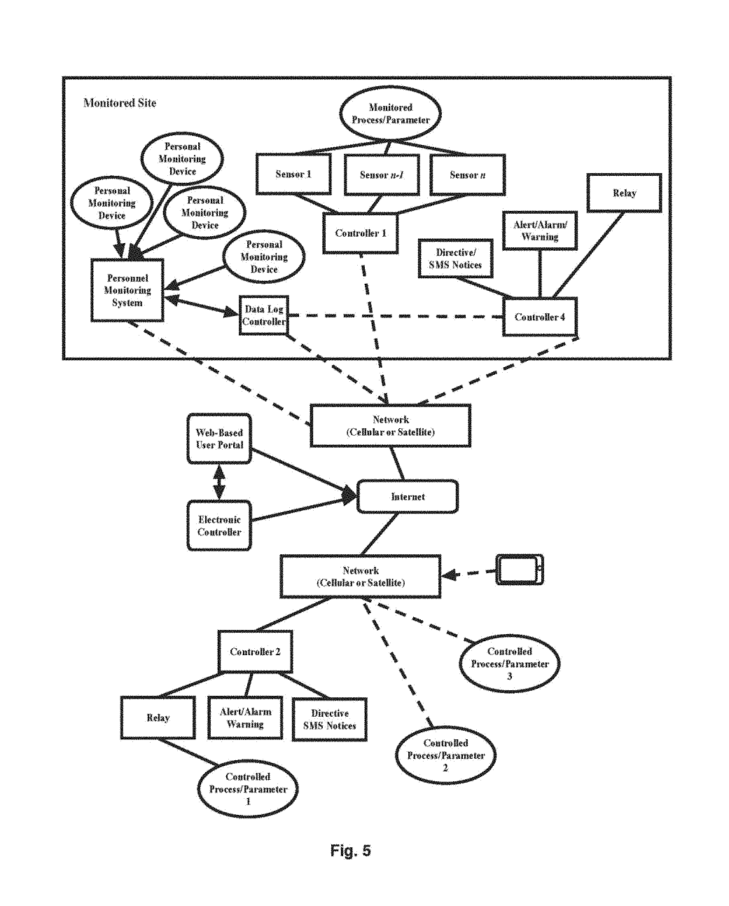

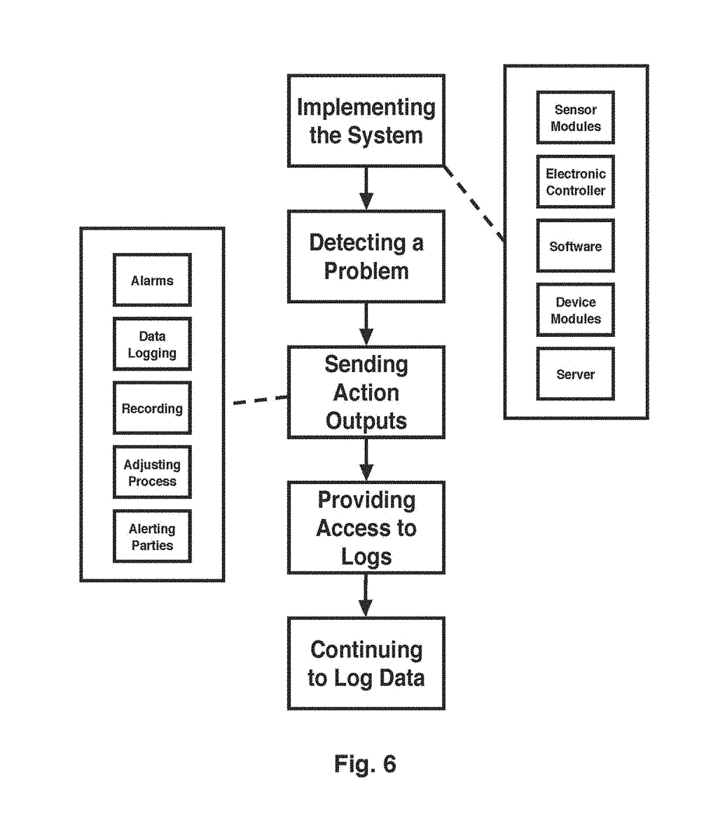

FIG. 3: A diagram showing an embodiment of a system for monitoring and/or controlling an industrial process or setting. The system shown in this figure is capable of use with the method shown in FIG. 1.

FIG. 4: Another embodiment of a system for monitoring and controlling an industrial process or setting showing an optional interface with a personnel monitoring system.

FIG. 5: A flow chart depicting a method for monitoring and controlling an industrial process or setting showing an optional interface with a personnel monitoring system.

FIG. 6 depicts a flow chart showing an embodiment of a method including the steps of implementing a process monitoring and control system and using that system to detect potential problems, and to generate appropriate action and alerts based thereon.

### DETAILED DESCRIPTION

Provided herein are methods and systems for monitoring and controlling industrial processes or activities in industrial setting.

Definitions & Abbreviations

Unless expressly defined otherwise, all technical and scientific terms, terms of art, and acronyms used herein have the meanings commonly understood by one of ordinary skill in the art in the field(s) of the invention, or in the field(s) where the term is used. In accordance with this description, the following abbreviations and definitions apply.

Abbreviations

The following abbreviations apply unless indicated otherwise:

CDMA: code division multiple access;

CPU: central processing unit;

DECT: Digital Enhanced Cordless Telecommunications;

EDGE: Enhanced Data Rates for GSM Evolution;

EV-DO: Evolution-Data Optimized;

FDMA: frequency division multiple access;

GSM: Global System for Mobile Communications;,

GPRS: General Packet Radio Service;

IAN: Internet area network;

iDEN: Integrated Digital Enhanced Network;

IP: Internet Protocol;

km: kilometers;

LAN: local area network;

LEO: low earth orbit;

LTE: Long Term Evolution;

PLC: programmable logic controller;

SCADA: supervisory control and data acquisition;

SMS: short messaging service;

UMTS: Universal Mobile Telecommunications System;

WAN wide area network; and

W-CDMA Wideband CDMA.

Definitions

“Industrial process” as used herein means any process that is used on a scale of commercial significance. Such processes are used in a wide variety of industrial settings, typically involve one or more of large-scale, harsh conditions, dangerous conditions, personnel safety, environmental risk, security risk, or the like. Industrial processes include operations related to procuring natural resources, transporting, processing, or manufacturing, utilities, defense operations, and many other industrial endeavors.

“Industrial setting” means any facility, site, location, plant, rig, tower, or any physical asset of a company or concern (whether public or private, governmental or non-governmental). Monitoring and control of industrial settings may be related to safety of personnel or property, security, the environment, local residents, or the like. A particular industrial setting may require monitoring and control of a industrial process located there, as well as monitoring and/or control of the facility or site more generally. For example, chemical plant may involve one or more industrial processes that are being monitored with respect to temperature of various feeds, fill level of tanks, extent of a reaction, and the like. Elsewhere within the same plant, other factors may be monitored and/or controlled such as security (e.g. perimeter access), air quality, including presence or absence of an undesired gas, radioactivity, or the like.

As used herein, a “parameter” of an industrial setting or an industrial process can comprise any value of interest and includes, but is not limited to one or more of temperature, internal pressure and/or external pressure (or pressure differentials), flow rate, humidity, fill level, viscosity, an measurement of electrical conditions (current, voltage, resistance, conductivity, and the like), vibration, the presence or absence of a particular gas (e.g. the presence of H₂S, CO, methane, propane, natural gas; or the absence of oxygen), the integrity of a structure or assembly, fouling of a process component, processing equipment, or the like (including biofouling), pH, acidity, a chemical substrate for or intermediate- or end-product of a reaction, the extent of completion of a chemical process, reaction rate, security at a processing site, one or more local atmospheric or oceanic conditions, and the like. For any of the foregoing a sensor may be used or developed to detect the ‘absolute’ value, a relative (or comparative) value, or a ‘delta’ or change in the parameter e.g. over time. For example in some operations, and reduction in flow rate and/or an increase in pressure may indicate fouling, clogging, blockage, or the like. In a filtration process, such parameters may signal the need for changing filtration medium or back-flushing a piece of process equipment, which in turn may require multiple valves to be opened and/or closed in proper sequence. Similarly, a sudden and unexpected change in pressure along a pipeline, supply line, or the like might indicate a problem at the source, or might indicate a breach or catastrophic failure. Parameters may be monitored on a periodic basis (e.g. separate measurements spaced over a period of time), semi continuous basis (e.g. multiple measurements made repeatedly, at a given interval predetermined or determined by the prior measurement relative to a desired setting), or continuous basis (wherein the parameter is measured on an ongoing basis). Parameters may have actionable limits, e.g. upper limits, lower limits, or upper and lower limits—falling outside of such limits will generally cause an output in response. An output may also be generated in response to a parameter that is within limits—such outputs may indicate that the parameter should be measured with the same or different frequency, or may indicate that the data should merely be logged appropriately as a record of a process or process condition.

As used herein “sensor module” is sometimes used as shorthand for a measuring sensor connected to or in communication with a PLC for reading and processing the signal locally, and a modem for transmitting or communicating the signal to a remote device via a cellular or satellite network, and optionally, an analog to digital converter for use where the original measurement is an analog signal. Such additional electronics as a PLC, modern, and/ or analog to digital converter are particularly included where evident from or implied by the context. A “sensor module” thus typically comprises means for measuring a parameter in combination with converting, processing, and/or signaling means that are able to convert an analog measurement into a digital signal, process that signal (e.g. by comparing that signal to a warning level, alert level, or action level), and/or send the signal to e.g. a programmable logic controller, a virtual controller, a CPU, a computer or other electronic device adapted to receive the signal. A sensor module may comprise up to a plurality of sensors in communication with a single PLC, and modem. A “sensor” means a detector, measuring means, gauge, or other instrument, or other apparatus capable of sensing or measuring a parameter. Both analog and digital sensors are well known in the art for measuring a wide variety of parameters. Sensors for use herein may utilize analog and/or digital measurement and/or signals. Preferably a sensor is an electronic sensor that is capable of acquiring the measured parameter as a digital signal. Digital measurements and signals may be read directly by the receiving device, e.g. a PLC or the like, and may be sent onward e.g. to a remote controller. Analog measurements and/or signals are preferably first converted into digital signals before sending the digital signal to a local or remote receiving device (or both).

As used herein a “device module” in the context of a device module capable of responding to an output” or similar expressions means a communications apparatus (e.g. a modem or the like) capable of communicating via a cellular or satellite network, preferably connected to or in communication with a PLC and one or more devices for carrying out an action. A device module can comprise up to a plurality of devices connected to or in communication with a single PLC and modem. A “device” can comprise an electronic relay, actuator, digital switch, or other apparatus capable of responding to a digital output by e.g. carrying out an action such as changing a process parameter, switching process equipment on or off, sending a message (e.g. a warning, alert, alarm, or the like). Preferably a device is an electronic sensor that is capable of taking an action directly or indirectly based on a digital output received. In some cases a taking an action comprises converting a digital output into an analog signal that can in turn cause a downstream actuator or the like to flip a switch, operate a valve, adjust a thermostat, change a control setting, or the like. Devices may handle analog or digital outputs. A device module may include a digital to analog converter able to convert the digital output into an analog signal that can be sent to e.g. a device adapted to utilize the analog signal. In use, a device module can receive an output via a cellular or satellite network, and that output can be optionally processed by a PLC or sent directly to a local device, which is adapted for responding to the output with an action such as adjusting a process parameter, altering a setting on process equipment, sending a warning, alert, or alarm, or the like.

As used herein, “outputs” mean a signal that is generated by the monitoring and control system. Preferably the signal is sent to a device capable of receiving it and carrying out an action in response thereto. The output is generally a digital output that is received by a digital device. The output may also be a digital signal that is converted to an analog signal such that an analog setting or control point may be changed. Outputs also include other ‘directives’ such as sending a alert, notification, reminder, or generating information for data logging.

By “action” is meant performing or doing a thing in the real or digital world. For example in the real world, an action can comprise any physical change, including changing a setting, flipping a switch (on to off or vice versa), or the like. Actions in the digital world can include generating messages, alerts, notifications, announcements, or reminders, and other information whether verbal or numeric, written or oral. Actions are preferably prioritized and grouped such that safety is the first priority. Safety includes safety for the people who are present at the industrial site or in the potentially affected, surrounding locale. Additional priorities include those actions related to avoid environment harm including spills, accidental releases of hazardous, noxious, toxic, or otherwise undesirable materials, compounds, etc. into the air, water, or soil at the site, nearby, or remote to the site (such actions may include changing process settings, turning on or off process equipment, initiating spill control, neutralization, containment, cleanup or the like). Still other priorities includes preserving data include logged data of measurements before, during, and after a problem, such data including audio and/or visual recordings of events in connection therewith may be valuable to many parties for determining the root cause of the problem, ways to prevent repeats or related issues in the future, financial and legal responsibilities or liabilities, and the like. Minimizing economic losses and legal liabilities are also important criteria that the actions can address in various embodiments. Examples of actions include, but are not limited to, sending one or more alerts (e.g. by email, short message system (SMS, i.e. ‘text’ messages) satellite, or the like), activating an alarm (including alarm sounds, flashing lights, announcements, voice directions, personal vibration or other notification devices, and the like, as may be required or useful under the circumstances), logging data locally, logging data remotely (including logging data to an accessible cloud drive or server), changing a local or remote process setting or processing parameter; switching local or remote process equipment on or off or adjusting a setting thereon; implementing an emergency or safety protocol; notifying an interested party; or activating a local or remote system for recording audio and/or visual information related to the signal.

As used herein “cellular or satellite network” means a wireless network such as is used for cellular or mobile phones, including networks utilizing variable or fixed-length packets of information. Cellular networks include but are not limited to networks employing technology such as 3G, 4G, 5G, CDMA, GSM, GPRS, cdmaOne, CDMA2000, W-CDMA, EV-DO, EDGE, FDMA, UMTS, DECT, Digital AMPS (IS-136/TDMA), and iDEN. Also included are networks utilizing Mobile WiMax and/or any technology based on or related to IEEE 802 standards, such as IEEE 802.16. Cellular networks include mobile or wireless broadband networks, whether licensed (e.g. by the FCC or similar regulatory body), or unlicensed, public or private. Cellular networks generally use radio spectrum frequencies classified as UHF, and generally range from about 450 MHz to about 2800 MHz and more often from about 700 MHz to about 2600 MHz. Satellite networks for use herein generally include satellite-based telephony networks that employ geostationary and/or low earth orbit (LEO) communications satellites that provide worldwide or nearly worldwide coverage. Such networks are capable of supporting typical types of communications of any telephony network, including short messaging service (SMS) messages.

“Internet” means the publicly accessible network commonly known as the Internet, including any protocols used for transmitting data packets thereon. A “similar network” means any public, private, or public/private network, whether or not connected to the public Internet, which uses similar principles of operation or architecture, or similar protocols. In particular, networks that are similar to the Internet may involve the transfer of packets of information and use of Internet protocols such as TCP/IP for transmitting data or that comprise multiple nodes capable of communicating with each other, and using Internet protocols or other network protocols for sending and receiving packets of data in a consistent and useful manner even where one or more nodes of the network are unable to communicate), or the like. Preferably such similar networks are global, or regional, or otherwise cover a sufficient geographic area to facilitate both local and remote monitoring and control of industrial systems or sites. Because of the presence of vast infrastructure, use of Internet is economically preferable, however may pose additional security concerns related to the industrial process or setting. In certain embodiments, similar networks that are not readily accessible from the public Internet may be preferred as they offer enhanced security. In other embodiments the communications are encrypted or other security measures are utilized to enable the use of the public Internet.

As used herein “substantially” may mean an amount that is larger or smaller than a reference item. Preferably substantially larger (or greater) or smaller (or lesser) means by at least about 10% to about 100% or more than the corresponding reference item. More preferably “substantially” in such instances means at least about 20% to about 100%, or more, larger or smaller than the reference item. As the skilled artisan will appreciate the term ‘substantially’ can also be used as in “substantially all” which mean more than 51%, preferably more than 60%, 67%, 70%, 75%, 80%, 85%, 90%, or more of a referenced item, number, or amount. “Substantially all” can also mean more then 90% including 91, 92, 93, 94, 95, 96, 97, 98, 99 or more percent of the referenced item, number, or amount.

As used herein, the singular form of a word includes the plural, and vice versa, unless the context clearly dictates otherwise. Thus, the references “a”, “an”, and “the” are generally inclusive of the plurals of the respective terms. For example, reference to “a sensor” or “an industrial process” includes a plurality of such “sensors” or “processes”.

The words “comprise”, “comprises”, and “comprising” are to be interpreted inclusively rather than exclusively. Likewise the terms “include”, “including” and “or” should all be construed to be inclusive, unless such a construction is clearly prohibited from the context. Further, forms of the terms “comprising” or “including” are intended to include embodiments encompassed by the phrases “consisting essentially of” and “consisting of”. Similarly, the phrase “consisting essentially of” is intended to include embodiments encompassed by the phrase “consisting of”.

Where used herein, ranges are provided in shorthand, so as to avoid having to list and describe each and every value within the range. Any appropriate value within the range can be selected, where appropriate, as the upper value, lower value, or the terminus of the range.

The formulations, compositions, methods and/or other advances disclosed here are not limited to particular methodology, protocols, and/or components described herein because, as the skilled artisan will appreciate, they may vary. Further, the terminology used herein is for the purpose of describing particular embodiments only, and is not intended to, and does not, limit the scope of that which is disclosed or claimed.

Although any formulations, compositions, methods, or other means or materials similar or equivalent to those described herein can be used in the practice of the present invention, the preferred formulations, compositions, methods, or other means or materials are described herein.

Any patents, patent applications, publications, technical and/or scholarly articles, and other references cited or referred to herein are in their entirety incorporated herein by reference to the extent permitted under applicable law. Any discussion of those references is intended merely to summarize the assertions made therein. No admission is made that any such patents, patent applications, publications or references are prior art, or that any portion thereof is either relevant or material to the patentability of what is claimed herein. Applicant specifically reserves the right to challenge the accuracy and pertinence of any assertion that such patents, patent applications, publications, and other references are prior art, or are relevant, and/or material.

### DETAILED DESCRIPTION OF ILLUSTRATIVE EMBODIMENTS

Systems and methods for monitoring and controlling industrial processes and industrial settings are provided herein. Such systems generally comprise:
a) a plurality of sensors or detectors, each capable of providing an analog or digital signal corresponding to a measurement or process parameter of an industrial process;
b) one or more sensor programmable logic controllers (‘PLCs’) local to and associated with the sensors or detectors, and in communication therewith;
c) a plurality of devices each capable of generating an analog or digital output for controlling a process or parameter of the measured process or a remote process in response to an output;
d) one or more device PLCs local to and associated with the devices and in communication therewith and adapted for receiving the signals from the signal PLCs and sending an output in response thereto;
e) means for communicating at least via a cellular or satellite network associated with both the sensor PLCs and the relay PLCs;
f) means for switching between the cellular or satellite network and the Internet or a comparable network; and
g) an Internet-accessible user portal.

The local PLCs generally comprise or are connected to and in communication with a variety of electronics and are adapted for reading, receiving, converting, and processing analog or digital signals from the sensors or detectors, receiving inputs, generating outputs, communicating with a cellular or satellite network, and evaluating a set of rules. In one embodiment, the PLCs are in communication with modem circuitry adapted for communicating via a cellular or satellite network. The sensor PLCs are local to the sensors, e.g. at the site of the monitored industrial process or setting.

The systems further include software comprising logic/programming instructions for the PLCs that provides the PLCs with functionality for one or more of:
(i) reading/receiving the analog or digital input signals from the one or more sensors or detectors;
(ii) reading the input signals, and determining, based on a set of rules provided in the programming, for each input signal, whether any action must be taken in response to that input signal;
(iii) generating one or more outputs in connection with monitoring, controlling, or providing information about the industrial process based on the input signals and the rules; and
(iv) communicating with a cellular or satellite network.

Thus, in a first aspect, this disclosure provides for monitoring and controlling an industrial process or an industrial setting. The methods generally comprise the steps of:

a) measuring one or more parameters associated with an industrial process or industrial setting with at least one sensor adapted for measuring the one or more parameters;

b) sending, via a cellular or satellite network, one or more signals corresponding to the one or more measurements to an electronic controller adapted for receiving and processing the signals;

c) transmitting the signals from the cellular or satellite network via the Internet or similar network to the electronic controller;

d) using the electronic controller for receiving and processing the signals using software comprising instructions executed by the electronic controller;

e) generating, using the electronic controller, one or more outputs in response to the signals;

f) transmitting the one or more outputs to one or more devices capable of responding to the outputs and adapted for receiving the outputs via a cellular or satellite network; and

g) executing one or more actions based on the output, on the monitored process or setting or at one or more remote processes or settings;

The electronic controller is preferably connected to and accessible via the Internet or similar network and connected to the sensors and the devices solely via the cellular or satellite network. In various embodiments, the signal and the output are digital but the parameter measured and the action executed may include digital or analog information.

The methods can be better understood with reference to the systems useful for carry out such methods, as depicted in the figures. FIG. 1 shows an overview of a monitoring and control system in accordance herewith.

As can be seen a plurality of sites (e.g. Remotes Sites 1 to n) are each provided with sensor modules adapted for communicating information about a measured parameter via a network comprising cellular or satellite communications. For the sake of clarity, this arrangement provides the ability of the system to be used in areas where there are no options for hard-wired connections or communications via line-of-site or antenna-based methods such as radio communications (including hand-held radios, or base stations). Thus, the systems disclosed herein are well-suited to truly remote locations, including unmanned and inaccessible locations where communications by other means are not available. The communications from a monitored process or site (not shown) are via circuitry adapted for such purposes (e.g. a modem or the like, not shown). The signal that has been sent via the cellular or satellite network is switched to the public Internet or a similar network and carried to an electronic controller (not shown) that is Internet-connected (or cloud-based).

The electronic controller is also adapted for communicating with a web-based user portal that is accessible from any location via a web-enabled device (e.g. a smart phone, tablet, laptop, or desktop computer). The electronic controller can generate an output signal that is capable of causing an action to be implemented at a remote site. The output is transmitted via the electronic controller and sent out via the Internet (or similar network). The output is switched to a cellular or satellite network for communication to the remote system to be controlled. For example, with further reference to FIG. 1, if Remote Site 1 is being monitored for a tank fill level, a sensor module sends a message containing signal corresponding to a measurement via the cellular or satellite network. The message is switched for delivery to the electronic controller on the Internet. The message and/or data can be observed by an operator or other user via the user portal from any Internet-accessible location. The electronic controller can determine whether the signal received requires an action to be taken, and if so, the controller can generate an output indicating that action should be taken. The output is transmitted via the Internet and switched to the cellular or satellite network for delivery to a Remote Site(s) where the action(s) are to be taken. In the foregoing example, several actions may be taken. The tank monitored at Remote Site 1 may be full, in which case the tank valve is closed to prevent overfilling. A supply line that is fed from Remote Site 4 may be turned off or by-passed to Remote Site 2 where a valve is opened to begin filling a tank there. In addition, a transportation carrier (such as a trucking or rail company) may be notified of a need for service at Remote Site 1 (e.g. to empty the tank, or pick-up a tank car, or the like).

The system and related methods can be further understood with reference to FIG. 2. A monitored process or parameter is shown in this flow chart showing an embodiment of the methods. A sensing module monitors the specific criterion that is measured. The sensing module preferably comprises one or more sensors, connected to and in communication with a local Processing Module (e.g. a PLC) that reads the sensor(s), and if needed, converts analog to digital information for a particular measurement. In some instances, the PLC may generate a local output to control a process parameter locally in the process or parameter being measured. The Sensing Module typically comprises or is associated with a Communications Module (e.g. a modem or the like) that is adapted for sending one or more digital signals via an available cellular or satellite network. The signal(s) will correspond to the measurement(s), and may optionally include such other information as may be useful. Examples of such information are identification of the process being monitored, location of the process being monitored, date and time stamps, identification and status of the sensor and or measuring device, confirmation of the measurement, confirmation of the authenticity of the message, actions taken locally, and the like.

The cellular or satellite message is switched to and further transmitted via the Internet or similar network and delivered to the Controller Module. The Controller Module comprises an electronic controller which may be a physical device, or a virtual controller. After receiving the message, the signals and other information are processed via the electronic controller, which according to its software instructions, determines whether any action is required based on the information received. If an action is required, the controller generates one or more output(s) that are sent to a Device Module at the monitored location (not shown) or to one or more Controlled Process or Parameter. The output message is initially transmitted via the Internet (or similar network) and then switched to a cellular or satellite network. The Device Module preferably contains a Communication Module for receiving the output message from the cellular or satellite network, and an optional Processing Module (e.g. a PLC or the like) for processing the output. The PLC is adapted to control the local devices connected to it. For example, the output may require a valve to close, a thermostat to be increased, or an exhaust fan to turn on.

In addition to the foregoing, as can be seen from FIG. 2, the Controller Module is also in communication with the Dashboard Module (e.g. a user portal). A user can observe all of the process measurements and/or alter or even override the actions determined by the system, or the user can simply make manual changes to the process via the Dashboard Module functions.

In various embodiments, the software executed by the electronic controller is stored on a network-accessible device, such as a server or a network drive. In certain embodiments the software is cloud-based. In various embodiments, one or more of the steps of reading, receiving, and processing the signal, generating the one or more outputs, and transmitting the one or more outputs, require reading the software and executing the instructions therein.

In certain embodiments the electronic controller is a physical controller. In other embodiments the controller is a virtual controller, i.e. it is entirely based in software, which is accessible via the Internet and/or is cloud based.

The methods in certain embodiments further comprise the step of accessing a dedicated or cloud-based device connected to and accessible from the Internet, such as a network server, network drive, cloud-based server, cloud accessible drive, or the like. The dedicated or cloud-based device can be used for storing the software for reading and execution by the PLC, and can also be used for logging or storing and/or streaming data or audio/visual content in connection with the monitoring and control system. Generally the cloud-based device is accessible from anywhere on the globe.

The methods require and are particularly adapted for use with cellular and or satellite networks, which helps facilitate the applicability of such systems to remote and/or unmanned locations. In various embodiments, the methods utilize a cellular or satellite network for both sending the monitoring signals from the sensors, and transmitting the outputs (e.g. for causing an action to occur, creating a alert, or logging data). In a presently preferred embodiment, the methods utilize the Internet (or similar network) to send/receive both the signals and outputs via the cellular or satellite network.

In several embodiments, the methods further comprise providing a web-based user portal in communication with the controller. The user portal typically comprises functions for:

a) reviewing one or more of the measured parameters;

b) a visual representation of the process;

c) viewing a status of any alarms, alerts, announcements;

d) receiving one or more advisories;

e) a visual representation of any outputs generated;

f) viewing a status of transmission of such outputs;

g) reviewing any actions taken in response to the outputs transmitted;

h) manually creating one or more outputs to control a parameter in a monitored or remote process;

i) manually triggering an action to control a parameter in a monitored or remote process;

j) overriding one or more outputs generated by the controller;

k) logging any information related to h), i), or j); or

l) any combination of one or more of the foregoing.

In various embodiments, the methods further comprise the step of logging data that is a) received by the electronic controller; b) transmitted by the electronic controller; c) related to operation of, processing by, or access to the electronic controller; d) related to access of an optional web-based user portal in communication with the controller; or e) a combination of one or more of the foregoing.

In certain embodiments, the methods further comprise the step of receiving and logging data from a personnel monitoring system. Typically the personnel monitoring system is located on premises at the industrial site where the process is located, but it may be otherwise located. An interface between the personnel monitoring system and the controller is present and allows communication therebetween. Preferably the personnel monitoring system is in communication with a CPU interfaced with the controller, or the monitoring system is in communication with the controller. The personnel monitoring system generally comprises personal proximity devices in communication with data recording points distributed in an area of the industrial process or industrial setting.

In various embodiments, the one or more actions in response to the generated outputs comprise one or more of logging data locally, logging data remotely, changing a local or remote process setting or processing parameter; switching local or remote process equipment on or off or adjusting a setting thereon; triggering an alarm or alert condition; notifying an interested party; implementing an emergency or safety protocol; or activating a local or remote system for recording audio and/or visual information related to a signal.

In one embodiment the action comprises notifying an interested party and the interested party comprises an employee, a supervisor, a manager, a mechanic, an engineer, a maintenance person, an executive, a regulatory authority, an emergency department, a health authority, an insurer, an investor, or a legal advisor.

In other embodiments the action comprises switching local or remote process equipment on or off, or adjusting a setting thereon. In certain such embodiments the process equipment is upstream or downstream of the sensor providing the measurement. These methods have broad applications. For example, if a pipeline experiences a substantial fault condition, such as a rupture or leak, the controller can immediately close upstream and downstream valves controlling product through that section of pipeline, turn off pumps or related equipment, open valves to divert flow or capture spillage. Those actions may take place yards, miles, or even hundreds of miles away from the sensor that first measures a problem condition as determined by the controller. Similarly, if an operation is filling a tank array, the system may close a local tank valve and open another valve, or alternatively it may determine that all local tanks are at maximum fill and shut a supply pump or close a supply valve that is located at a substantial distance from the sensor detecting a full tank.

While an action caused by the method can occur in process equipment that located locally or remotely, as described above, the action can also occur at location that is unmanned or not manned continuously. Such methods are useful in a variety of circumstances. For example some monitoring applications may involve monitoring industrial setting or processes such as supply pipelines, transmission lines, remote installations or sub-installations, inaccessible locations (e.g. remote locations including extreme weather conditions, offshore sites, underwater installations, and the like) that are either completely unmanned, or only manned intermittently, for example during routine or non-routine maintenance operations.

It is particularly useful to be able to monitor the processes and/or remotely trigger actions at such installations from a vast distance without the need for a human to be physically present, particularly when the possibility of consequences to health, environmental damage, financial loss, legal liability and the like may result from delays in triggering action(s).

In certain embodiments, industrial safety is a primary issue, and the action comprises triggering an alarm or alert condition or implementing an emergency or safety protocol. The safety of personnel (e.g. employees, contractors, visitors, and the like) in an industrial setting is always paramount. In one embodiment, preferably one or more of the following occurs:
a personal proximity detection system is activated to alert employees of an emergency status;
verbal instructions are provided via one or more emergency communication devices (providing one-way or two-way communications),
personnel are directed to proceed a muster station,
or the location of each person who has entered to area is tracked and such information is logged to a remote cloud-based device.

In some embodiments, the personnel proximity detection system comprises a device, such as a tag or the like that is worn or carried by each employee. These personal monitors preferably include e.g. an RFID device (for tracking passage or proximity to one or more access point detectors capable of reading the RFID tag), a GPS device (for determining the specific location of the person wearing or carrying the GPS device), means for measuring one or more vital signs of the employee (e.g. pulse rate/heart rate, body temperature (and/or core temperature), breathing rate, etc.), and/or a one-way or two-way communication device. Preferably the personnel proximity detection system further comprises access points at least at every entrance and exit adapted for logging each person (employee, contractors, visitor, or the like) who entered or exited an area including the process or the industrial setting.

In one embodiment, the sensor measures intermittently or continuously, or either upon request by the controller. In some cases where a measured parameter has an actionable level, it is useful to measure more frequently, or to switch from intermittent to continuous monitoring/measure as a limit is approached. E.g., as a tank approaches a maximum fill level, more frequent or even continuous measurements can become critical to ensure that the desired fill level is not passed. Similarly, if a gas detection measurement indicates a small ‘blip’ in a measurement, it may be vital to personal safety to measure continuously until the system determines that the concern has passed, or that indeed the gas is present and removal procedures and/or safety protocols or evacuation procedures should be implemented to protect people in the location of the measurement or nearby areas.

Thus, in one embodiment, at least one measurement pertains to gas detection. Such embodiments are preferably consistent with the foregoing description. The next aspect of this disclosure pertains to methods more focused on methods of monitoring gas (e.g. gas detection) and control of industrial processes or settings where a likelihood or possibility of gas is a concern.

In certain embodiments, methods comprise actions comprise sending one or more alerts, activating an alarm, logging data locally, logging data remotely, changing a local or remote process setting or processing parameter; switching local or remote process equipment on or off or adjusting a setting thereon; implementing an emergency or safety protocol; notifying an interested party; or activating a local or remote system for recording audio and/or visual information related to the signal

In various presently preferred embodiments, the process equipment being controlled, i.e. being switched on or off, or having adjustments made thereto is at a remote location that is unmanned or not manned continuously. For purposes herein, remote means more than 0.25, 0.5, or 1 mile from the process being monitored. In various embodiments remote equipment or remote sites may be more than 1, 10, 50, 100, 200, or 500 miles, or even 1000 or more miles from the process being monitored.

In a second of it several aspects, the disclosure provides methods for monitoring and responding to the presence of a gas of interest (e.g. an unpleasant, harmful, toxic, noxious, explosive or otherwise undesirable gas) in an industrial process or an industrial setting. The gas may be indicative of a process leak, safety risk, risk of explosion or similar catastrophic event, risk to health or life, and/or other urgent situation. The methods for gas detection generally comprise the steps of:

a) measuring one or more parameters associated with the presence of a gas in an industrial process or industrial setting with at least one sensor adapted for measuring the parameter;

b) reading the measurement with a PLC;

c) sending a signal corresponding to the gas measurement via a cellular or satellite network to an electronic controller adapted for receiving the signal;

d) comparing the signal to a desired value using software comprising instructions executed by the electronic controller;

e) determining whether the gas is present at an actionable level based on the signal;

f) generating, using the electronic controller, one or more outputs in response to the signal;

g) transmitting the one or more outputs, via a cellular or satellite network to one or more device modules adapted for receiving the output and taking an action in response thereto; and

h) executing one or more actions based on the output.

In various embodiments, the one or more signals and the one or more outputs comprise analog or digital information. In such embodiments, the methods can comprise the additional step of converting the data from analog to digital or vice versa, using, for example, a converter adapted for interconverting such data; and wherein the signals and the outputs may be sent wirelessly to any location on the globe.

In certain embodiments, e.g. where the gas is not detected or is below an actionable level, the action may be to maintain status quo, e.g. continue the monitoring process, and logging the data. In other embodiments, e.g. where the gas is present, or present at or above an actionable level, the actions may include one or more of triggering a safety alert or alarm condition, initiating an emergency evacuation, initiating a shut-down of one or more processing operation, activating a recording system for audio/visual recording, communicating with a personnel monitoring system, continuing to log data, or the like. Other such actions are contemplated for use herein, including actions that are primarily local and actions that may require operations at a remote location.

In various embodiments, the step of measuring the presence of the gas may be replaced with a step of monitoring the concentration of the gas above, below, or outside established thresholds for the gas.

The methods can be further understood with reference to FIG. 3. The methods comprise a) steps that occur locally at the monitored process; b) steps that occur in a network environment at any location; and c) steps that occur locally at the remote or controlled process. The methods, as with the other methods and systems disclosed herein generally, utilize a cellular or satellite network to send the signals and to receive the outputs. Those communications are transferred or ‘switched’ to the Internet and the intermediate communications are also transmitted via the Internet (or similar network). Such ‘switching’ generally occurs using equipment associated with the public telephone network or the like.

With further reference to FIG. 3, a process parameter, e.g. a gas concentration, the presence of a gas, the partial pressure of a gas, or the rate of change of a parameter related to the gas are measured using a sensor. The measurement is read, preferably using a PLC that is local to the process and in communication with the sensor(s). The measurement is then converted into a signal that can be sent via an available cellular or satellite network. Optionally, an additional step (not shown) is provided if required for converting analog data to a digital signal.

The sent signal is transmitted via the cellular or satellite network and subsequently switched to the Internet where it can be received by the Central Controller that is connected to and accessible via the Internet. The received signal is then compared to one or more criteria for the measured parameter. The Central Controller then determines, based on the comparison whether an action is required. The action may comprise any one or more of logging data, changes in a process parameter at the monitored site or a remote site, turning equipment on or off, or adjusting equipment, providing a notification, warning, or alert, sounding an alarm, initiating an audio or visual recording at the monitored site, trigger an evacuation plan for worker or others at the site being monitored, shutting down a process, or the like. If an action is required the Central Controller generates one or more outputs corresponding to the actions required, and transmits one or more messages comprising the outputs via the Internet.

The transmitted message(s) comprising the output(s) are switched to a cellular or satellite network and received at the process to be controlled. The output is processed locally at the remote site and an action is executed in accordance with the output. Typically, a PLC is present at the remote site, and comprises communication with modem functions that permit the receipt of the message comprising the output.

In another of its several aspects, this disclosure provides systems for monitoring and controlling an industrial process. An embodiment of such a system is shown in FIG. 4. The systems generally comprise:

one or more sensor modules adapted for measuring one or more parameters associated with an industrial process or setting and sending a signal corresponding to the measurement via a cellular or satellite network;

an electronic controller adapted for receiving and processing signals from each of the plurality of sensor modules, generating one or more outputs in response to each signal, and transmitting the outputs;

software adapted for execution by the electronic controller and comprising instructions for processing each signal, and determining what actions to take in response to such signals, generating outputs to accomplish the desired actions, and transmitting the outputs to devices modules at the monitored process or setting, or at one more remote industrial processes or industrial settings; and

a plurality of device modules adapted for receiving the outputs and taking an action in response thereto.

In various embodiments, the electronic controller is connected to and accessible via the Internet or a similar network and is in communication with the sensor modules and the device modules at least via a cellular or satellite network. In one embodiment, the one or more signals and the one or more outputs comprise digital information. The signals are at least initially sent and the outputs are at least finally received via a cellular or satellite network. Between the initial sending and the final receipt, intermediate transmission is via the Internet or similar network, i.e. the communication is switched to the Internet for signals subsequent to being sent and for outputs prior to being received, respectively.

In various embodiments, the electronic controller is a physical controller or a virtual controller. The software for either a physical or a virtual controller can be cloud-based.

In one embodiment, the system further comprises a cloud device such as a drive or server, or the like. The cloud device is suitable for storing information regarding the monitored or controlled process or setting, serving the software in a form readable by the controller, or both. The cloud device provides the advantage of being accessible from any location with Internet access.

The system, in particular the sensor modules in one embodiment comprise sensors for measuring one or more of temperature, pressure, flow rate, fill level, viscosity, pH, a measurement of electrical conditions, vibration, the presence of concentration of a particular gas, the integrity of a structure or assembly, fouling or biofouling of a process component, the substrate for or end product of a chemical reaction, a chemical intermediate or by-product, the extent of completion of a chemical process, security at a processing site, or one or more local atmospheric or oceanic conditions, any combination of the foregoing, or changes over time in any of the foregoing.

In a presently preferred embodiment the system further comprises a server serving a web-based user portal in communication with the controller. The web-based user portal comprises functions for:
a) reviewing one or more of the measured parameters;
b) a visual representation of the process;
c) viewing a status of any notifications, warnings, alarms, alerts, announcements, or the like;
d) receiving one or more advisories;
e) a visual representation of any outputs generated;
f) viewing a status of transmission of such outputs;
g) reviewing any actions taken in response to the outputs transmitted;
h) manually creating one or more outputs to control a parameter in a monitored or remote process;
i) manually triggering an action to control a parameter in a monitored or remote process;
j) overriding one or more outputs generated by the controller;
k) logging any information related to h), i), or j); or
l) any combination of one or more of the foregoing.

The system in certain embodiments further comprises a network-accessible device adapted for logging data that is a) received by the electronic controller; b) transmitted by the electronic controller; c) related to operation of, processing by, or access to the electronic controller; d) related to access of an optional web-based user portal in communication with the controller; e) obtained from a personnel monitoring system in communication with the controller or f) a combination of one or more of the foregoing.

The system is adapted for use with personnel monitoring systems and in particular with any system for enhancing the safety of people on site or near the site of an industrial process or the like. In embodiments with a personnel monitoring system, the personnel monitoring system generally comprises a plurality of personal proximity devices in communication with data recording points distributed in an area of the industrial process or industrial setting. Such systems are known in the art.

In one embodiment, the system provided herein is adapted for causing an action that comprises one or more of logging data locally, logging data remotely, changing a local or remote process setting or processing parameter; switching local or remote process equipment on or off or adjusting a setting thereon; triggering an alarm or alert condition; making an announcement; notifying an interested party; implementing an emergency or safety protocol; or activating a local or remote system for recording audio and/or visual information related to the signal.

The action in one embodiment involves notifying an interested party such as an employee, a supervisor, a manager, a mechanic, an engineer, a maintenance person, an executive, a regulatory authority, an emergency department, a health authority, an insurer, an investor, a legal advisor, or the like.

In certain embodiments, the system is adapted for causing an action that comprises switching local or remote process equipment on or off, or adjusting a setting thereon. Preferably in some embodiments the process equipment is upstream or downstream of the sensor providing the measurement. The process equipment can be local or remote to the sensor. In other embodiments, the process equipment is at a remote location that is unmanned or not manned continuously.

In various embodiments, the system is particularly adapted for causing an action that comprises triggering an alarm or alert condition or implementing an emergency or safety protocol. One or more of the following can occur in such embodiments: a personal proximity detection system is activated to alert employees of an emergency status, verbal instructions are provided via one or more emergency communication devices, employees are directed to proceed a muster station, or the location of each employee who has entered an area is tracked and such information is logged to a remote network accessible device.

The personal proximity detection system preferably includes a device (such a tag, clip, belt-worn device, handset, headset, etc.) worn or carried by each employee that includes one or more of an RFID device, a GPS device, means for measuring one or more vital signs of the employee, and a one-way or two-way communication device for communicating to the employee by providing SMS messages, voice instructions, direction indicator(s), proximity alerts, local conditions, coordinates or the like. The personal proximity detection system further comprises access points at least at every entrance and exit, and optionally at other data collection points adapted for logging each employee who entered, exited, or passed (within a defined proximity of such point) an area including the process or the industrial setting.

The system typically includes sensors that are adapted for measuring intermittently or continuously, or either, upon request by the controller. In one embodiment, the frequency of an intermittent measurement can be adjusted by the controller.

In one embodiment, the system includes at least one sensor is adapted for detecting an undesirable or toxic gas in the air and ensuring the safety of workers in connection with the industrial process or setting.

Generally, the sensors and the devices each are connected to a program logic controller. The PLC comprises circuitry sufficient for communicating via a cellular or satellite network, or the PLC is in communication with a modem suited for so communicating.

The foregoing system can be further understood with reference to FIG. 4. As can be seen, a Monitored Process or Parameter comprises a plurality of sensors (Sensors 1 to 7 shown) which are measuring various parameters of a industrial process or at an industrial setting. The Sensors are in communication with Sensor Controller 1 which can read the measurements and process them locally. Controller 1 is able to utilize a modem or similar circuitry to communicate message(s) including the signal corresponding to the measurement(s) via a cellular or satellite network. The messages may include such additional information as may be useful for the monitoring and controlling. The message is switched from the cellular or satellite network to the Internet or similar network.

The messages including the signals are preferably received by a server that serves software for the Electronic Controller which may be a physical or virtual controller. The server also serves a web-based user portal which communicates with and receives the same information as the Electronic Controller. The server may be a dedicated server or may be cloud-based, and is connected to and accessible via the Internet.

The Electronic Controller executes instructions from network-accessible software (not shown) to process the information received from the monitored process. The software may include various action levels and similar criteria and decision paths that provide information on what actions need to be taken after receiving the signal messages. The Electronic Controller is also adapted for generating one or more outputs corresponding to actions to be taken at one or more locations. The Electronic Controller is further adapted for communicating the outputs to one or more remote locations (e.g. Controlled Process) and/or back to the Monitored Process. The communications are sent via the Internet, and switched to a cellular or satellite network with a final destination of the remote or Controlled Process. Device Controllers (e.g., Device Controllers 2 and 3) are equipped with a modem or similar circuitry adapted for communicating via a cellular or satellite network. The Device Controller(s) process the outputs received and instruct one or more Relays or other devices to carry out actions in accordance with the outputs. For example, Relays 1 and 2, Alert/Alarm/Warning device or a Directive/SMS device may all carry out certain actions including for example, logging data, turning process equipment on or off, adjusting process parameters, sending notifications, posting warnings, alerts, raising alarms, triggering recording equipment for audio and/or visual recording, initiating a personnel safety or evacuation plan, or the like.

As can be seen by those skilled in the art, the first and last communications in the system are via the cellular or satellite network(s). E.g., the signals from the site/process/parameter being measured or monitored are initially communicated via a cellular or satellite network. Similarly, the final output to generate an alert or control the monitored site (or process/parameter being monitored) or a remote site (or process/parameter being controlled) is communicated via a cellular or satellite network. Transmission of signals and communications between the first and the last of the system is carried via the Internet or similar network, and the information may be passed to or processed by a central electronic Controller in communication with an Internet-accessible user portal. The user portal may be accessed from virtually anywhere via e.g. the Internet.

It should also be noted that system is capable of and adapted for running an a fully automated mode that is only limited in its complexity by the software instructions or programming of the Electronic Controller. The more complex and involved the ‘rules’ and criteria that are developed, the higher the degree of hand-off automation involving multiple sites, processes, or systems being monitored, and multiple sites, processes, or systems being controlled including both local and remote sites, processes, or systems to the monitored processes. The system also provides for human interaction or intervention. There are two manners in which a human user can directly manipulate the controlled process. The first is via the Internet-accessible User Portal. A user with proper credentials can modify or control any connected function, parameter, equipment or the like on any monitored or controlled site via the User Portal (or Dashboard). In addition to control via the User Portal, the system provides the unique ability for a user, operator or the like to directly control any connected function, parameter, equipment, or the like via the cellular or satellite network. The user can directly send an output message to the remote Device Controller to assert such control.

With further reference to the figures, FIG. 5 depicts a further embodiment of this aspect, including an optional interface with a personnel monitoring system. As can be seen Monitored Site comprises a Monitored Process or Parameter, as in the prior figure (FIG. 4). Monitored Site also includes a Personnel Monitoring System comprises a plurality of Personal Monitoring Devices (Personal Monitoring Devices 1-4) which are in communication with a plurality of data access points at entrances, exits, and optionally at other key or strategic points throughout the Monitored Process and the Monitored Site. A data log and Controller are in communication with the Personnel Monitoring System and a constant/real time log of all personnel in the Monitored Site is maintained. Preferably, the Data Log is connected to/accessible via the Internet. However, redundancy can be provided by sending the data via the Internet (if available) or via the cellular or satellite network for additional storage via the Electronic Controller.

In addition, the Sensor Controller and the Data Log/Controller preferably are both in communication with the core Personnel Monitoring System.

Monitoring functions are as previously described. Sensors 1 to n measure one or more parameter of Monitored Process. The Sensor Controller 1 reads the measurement data and can process and send signals via the cellular or satellite network as in the previous embodiments. The Electronic Controller can receive and process the signals, and generate outputs as previously discussed. In the event of a process failure, unsafe condition, emergency, or the like, the Electronic Controller can send outputs to various remote sites such as Controlled Processes 1, 2, and 3, e.g. to shut down or otherwise control upstream or downstream processes. The Controller can also send outputs to Controllers 4, local to the Monitored Process, where Controller 4 is connected to and/or in communication with the process control devices such as Relay, Alert/Alarm/Warning Device, and the Directive/SMS messenger devices. The skilled artisan will appreciate the Controller 1 and Controller 4 may be a single controller in certain embodiments. Controller 4 is also in communication with Data Log/Controller and/or the core Personnel Monitoring System. This allows Controller 4 in response to an output received from the Electronic Controller, to activate personnel evacuation procedures, alarms, alerts, trigger recordings, and the like, via the Personnel Monitoring System. The Alert Device in communication with Controller 4 can send alerts receivable on the Personal Monitoring Devices. Moreover, in one embodiment, a further element of redundancy can be provided in that the Electronic Controller can communicate with the Personnel Monitoring System ‘directly’ by sending a message via cellular or satellite to a modem or the like in communication with the core Personnel Monitoring System.

As with the prior embodiments, the user can oversee the process monitoring and control system via the user portal, or directly with a cellular or satellite network—enabled device such as a smart phone, tablet, or satellite phone.

In yet another of its several aspects, this disclosure provides methods of mitigating the safety, environmental, economic, or legal consequences of an industrial problem or accident. The methods generally comprise the steps of:
a) implementing a system for monitoring and controlling an industrial process or setting comprising:
   i) one or more sensor modules adapted for measuring one or more parameters associated with an industrial process or setting and sending a signal corresponding to the measurement via a cellular or satellite network;
   ii) an electronic controller adapted for receiving and processing signals from each of the plurality of sensor modules, generating one or more outputs in response to each signal, and transmitting the outputs;
   iii) software adapted for execution by the electronic controller and comprising instructions for processing each signal, and determining what actions to take in response to such signals, generating outputs to accomplish the desired actions, and transmitting the outputs to devices modules at the monitored process or setting, or at one more remote industrial processes or industrial settings;
   iv) a plurality of device modules adapted for receiving the outputs and taking an action in response thereto; and
   v) at least one server for storing information regarding the process, serving the software in a form readable by the controller, and serving a web-based user portal; wherein the server and user portal are accessible from any location via the Internet or similar network;
wherein the electronic controller is in communication with the sensor modules and the device modules at least via the cellular or satellite network; and in communication with the server via the Internet or similar network
b) employing the system to detect a signal indicative of a potential problem or accident with safety, environmental, economic, or legal consequences; and
c) sending outputs via the system for one or more of the following:
   i) activating one or more alarms or emergency evacuation systems for any personnel in the vicinity of the problem or accident;
   ii) logging useful data in connection to the problem or accident; said data comprising at least the signals corresponding to process measurements;
   iii) activating a local or remote system for recording audio and/or visual information related to the problem or accident;
   iv) switching on or off, or adjusting a setting in one or more aspects of the industrial process or a remote process; and
   v) alerting one or more parties comprising an engineer, a manager, first responders, an executive, a regulatory authority, an emergency department, a health authority, an insurer, a legal advisor, or an investor about the problem;

d) providing access to the logged data to one or more of the parties alerted; and

e) continuing to log available data related to or about the problem or accident.

In a presently preferred embodiment, the system implemented further comprises a personnel-monitoring system, and interfaces with the personnel monitoring system via the controller, or via an optional component such as a CPU or other component adapted for communicating with the personnel monitoring system. The personnel monitoring system preferably comprises personal proximity devices (or personal monitors) in communication with data recording points (such as access points (at least all entries and exits) distributed in an area of the industrial process or industrial setting. The communication between the personnel monitoring system with the controller (or CPU, etc. adapted for such purpose) allows for sending data therefrom to the controller for logging, including logging at remote locations such as on the cloud device.

In various embodiments, the logged data on the cloud based device are encrypted to improve security. Such data can include the personnel monitoring system data as well as audio or video data from the location, process data and the like. Preferably, the logged data on the cloud based or the audio and/or video information, or both can be accessed on real-time or near real-time by one or more of the alerted parties.

In specific embodiments of these methods, the industrial process or industrial setting is an oil or gas rig, an offshore operation, a drilling operation, a refinery, a fracking operation, a mining operation, a chemical production, or packaging operation, a power generation or distribution facility, a pipeline operation, a manufacturing plant, a transportation or shipping operation, a munitions or defense operation, or a remote operation or aspect in connection with any of the foregoing.

In one embodiment, the industrial process is unmanned or not manned on a continuous basis. In some embodiments, the nature of the industrial process makes it impractical or impossible for the process or a portion thereof from being manned. Examples of such processes involve extreme conditions comprising temperature, pressure, hazardous chemicals, noxious fumes, hazardous conditions, radioactivity, or inaccessibility. More specifically, the location may be so remote as to preclude regular travel, or the area may be too immense to permit routine presence of a person on a regular basis. In other examples, an operation my be offshore, under water (including extreme depths) and so forth.

In yet another embodiment, the method further comprises the step of permitting two or more alerted parties communicating via means that facilitate two or more of the alerted parties communicating directly with each other, preferably while also accessing the logged data on the cloud based device, or the audio and/or video information, or both in real time or near real-time.

FIG. 6 depicts a flow chart showing an embodiment of this aspect. The methods include the steps of implementing a process monitoring and control system and using that system to detect potential problems, and generating appropriate action and alerts based thereon. In particular the methods provide for alerting interested parties or stakeholders regarding any safety, environmental, legal, economic or similar problems with an industrial process or setting.

With further reference to FIG. 6, the methods involve implementing a system for process monitoring and control. The system generally comprises a plurality of sensor modules for measuring process parameters and sending signals corresponding thereto, an electronic controller for processing the signals and generating outputs in response thereto, software comprising instructions for the controller, a plurality of device modules for receiving the outputs and carrying out actions based thereon, and a server for serving the software and logging data. The implemented system is used (via the sensor modules) for detecting problems or measurements of parameters that are indicative of problems related to safety, environment, economic, or legal consequences. The measurements are processed be the electronic controller based on criteria for determining whether action must be taken, and outputs are generated and communicated to the device modules. The device modules can carry out a variety of actions including triggering alarms, causing data to be logged, activating a recording system for recording visual or audio data from the site with a detected problem, adjusting process equipment or parameters (including switching equipment on or off), and alerting one or more stakeholders or interested parties. The parties are provided with real-time or near real time access to the data logs, and data logging is continued, including the logging of data such as the recorded site data, ongoing measurements, and the like.

The scope of the invention is set forth in the claims appended hereto, subject, for example, to the limits of language. Although specific terms are employed to describe the invention, those terms are used in a generic and descriptive sense and not for purposes of limitation. Moreover, while certain presently preferred embodiments of the claimed invention have been described herein, those skilled in the art will appreciate that such embodiments are provided by way of example only. In view of the teachings provided herein, certain variations, modifications, and substitutions will occur to those skilled in the art. It is therefore to be understood that the invention may be practiced otherwise than as specifically described, and such ways of practicing the invention are either within the scope of the claims, or equivalent to that which is claimed, and do not depart from the scope and spirit of the invention as claimed.

What is claimed is:

1. A method for monitoring and controlling an industrial process or an industrial setting, comprising the steps of:
measuring one or more parameters associated with an industrial process or industrial setting with at least one sensor modules adapted for measuring the one or more parameters;
sending, via a cellular or satellite network, one or more signals corresponding to the one or more measurements to an electronic controller adapted for receiving and processing the signals;
transmitting the signals from the cellular or satellite network via the Internet or similar network to the electronic controller;
using the electronic controller for receiving and processing the signals using software comprising instructions executed by the electronic controller;
generating, using the electronic controller, one or more outputs in response to the signals;
transmitting the one or more outputs to one or more devices capable of responding to the outputs and adapted for receiving the outputs via a cellular or satellite network; and
executing one or more actions based on the output, on the monitored process or setting or at one or more remote processes or settings;
wherein the electronic controller is located on and accessible via the Internet or similar network and connected to the sensors and the devices solely via the cellular or satellite network; and wherein the signal and the output are digital but the parameter measured and the action executed may include digital or analog information.

2. The method of claim 1 wherein the software executed by the electronic controller is stored on a network-accessible device and wherein one or more of the steps of receiving and processing the signal, generating the one or more outputs, and transmitting the one or more outputs require reading the software and executing the instructions therein.

3. The method of claim 2 wherein the electronic controller is a virtual controller and the software is cloud based.

4. The method of claim 1 further comprising a web-based user portal in communication with the controller, comprising functions for a) reviewing one or more of the measured parameters; b) a visual representation of the process; c) viewing a status of any alarms, alerts, announcements; d) receiving one or more advisories; e) a visual representation of any outputs generated; e) viewing a status of transmission of such outputs; f) reviewing any actions taken in response to the outputs transmitted; g) manually creating one or more outputs to control a parameter in a monitored or remote process; h) manually triggering an action to control a parameter in a monitored or remote process; i) overriding one or more outputs generated by the controller; j) logging any information related to g), h), i); or j) any combination of one or more of the foregoing.

5. The method of claim 1 further comprising the step of logging data that is a) received by the electronic controller; b) transmitted by the electronic controller; c) related to operation of, processing by, or access to the electronic controller; d) related to access of an optional web-based user portal in communication with the controller; or e) a combination of one or more of the foregoing.

6. The method of claim 1 further comprising the step of the logging data from a personnel monitoring system in communication with the controller, said personnel monitoring system comprising a plurality of personal proximity devices in communication with data recording points distributed in an area of the industrial process or industrial setting.

7. The method of claim 1 wherein the one or more actions comprise one or more of logging data locally, logging data remotely, changing a local or remote process setting or processing parameter; switching local or remote process equipment on or off or adjusting a setting thereon; triggering an alarm or alert condition; making an announcement; notifying an interested party; implementing an emergency or safety protocol; or activating a local or remote system for recording audio and/or visual information related to the signal.

8. The method of claim 7 wherein the action comprises notifying an interested party and the interested party comprises an employee, a supervisor, a manager, a mechanic, an engineer, a maintenance person, an executive, a regulatory authority, an emergency department, a health authority, an insurer, an investor, or a legal advisor.

9. The method of claim 7 wherein the action comprises triggering an alarm or alert condition or implementing an emergency or safety protocol, and one or more of the following occurs: an personal proximity detection system is activated to alert employees of an emergency status, verbal instructions are provided via one or more emergency communication devices, employees are directed to proceed a muster station, or the location of each employee who has entered to area is tracked and such information is logged to a remote cloud-based device.

10. The method of claim 9 wherein the personal proximity detection system comprises a device worn or carried by each employee that includes one or more of an RFID device, a GPS device, means for measuring one or more vital signs of the employee, a one-way or two-way communication device, and access points at least at every entrance and exit adapted for logging each employee who entered or exited an area including the process or the industrial setting.

11. A system for monitoring and controlling an industrial process or industrial setting comprising:
one or more sensor modules adapted for measuring one or more parameters associated with an industrial process or setting and sending a signal corresponding to the measurement via a cellular or satellite network;
an electronic controller adapted for receiving and processing signals from each of the plurality of sensor modules, generating one or more outputs in response to each signal, and transmitting the outputs;
software adapted for execution by the electronic controller and comprising instructions for processing each signal, and determining what actions to take in response to such signals, generating outputs to accomplish the desired actions, and transmitting the outputs to devices modules at the monitored process or setting, or at one more remote industrial processes or industrial settings; and
a plurality of device modules adapted for receiving the outputs and taking an action in response thereto;
wherein the electronic controller is accessible via the Internet or a similar network and is in communication with the sensors and the devices at least via the cellular or satellite network; the one or more signals and the one or more outputs comprise digital information; and wherein the signals are sent and the outputs are received via a cellular or satellite network and transmission is via the Internet or similar network, for signals subsequent to being sent and for outputs prior to being received, respectively.

12. The system of claim 11 wherein the electronic controller is a virtual controller.

13. The system of claim 11 further comprising a cloud device for storing information regarding the monitored or controlled process or setting; serving the software in a form readable by the controller, or both; wherein the cloud device is accessible from any location.

14. The system of claim 11 wherein the sensors comprise sensors for measuring one or more of temperature, pressure, flow rate, fill level, viscosity, pH, a measurement of electrical conditions, vibration, the presence of concentration of a particular gas, the integrity of a structure or assembly, fouling or biofouling of a process component, the substrate for or end product of a chemical reaction, a chemical intermediate or by-product, the extent of completion of a chemical process, security at a processing site, or one or more local atmospheric or oceanic conditions, any combination of the foregoing, or changes over time in any of the foregoing.

15. The system of claim 11 further comprising a server serving a web-based user portal in communication with the controller; wherein the web-based user portal comprises functions for a) reviewing one or more of the measured parameters; b) a visual representation of the process; c) viewing a status of any alarms, alerts, announcements; d) receiving one or more advisories; e) a visual representation of any outputs generated; f) viewing a status of transmission of such outputs; g) reviewing any actions taken in response to the outputs transmitted; h) manually creating one or more outputs to control a parameter in a monitored or remote process; i) manually triggering an action to control a parameter in a monitored or remote process; j) overriding one or more outputs generated by the controller; k) logging any information related to h), i), or i); or l) any combination of one or more of the foregoing.

16. The system of claim 11 further comprising a network-accessible device adapted for logging data that is a) received by the electronic controller; b) transmitted by the electronic controller; c) related to operation of, processing by, or access to the electronic controller; d) related to access of an optional web-based user portal in communication with the controller; e) obtained from a personnel monitoring system in communication with the controller or f) a combination of one or more of the foregoing; wherein the personnel monitoring system comprises a plurality of personal proximity devices in communication with data recording points distributed in an area of the industrial process or industrial setting.

17. The system of claim 11 adapted for causing an action that comprises switching local or remote process equipment on or off, or adjusting a setting thereon, and wherein the process equipment is upstream or downstream of the sensor providing the measurement.

18. A method of mitigating the safety, environmental, economic, or legal consequences of an industrial problem or accident comprising the steps of:
implementing a system for monitoring and controlling an industrial process or setting comprising:
one or more sensor modules adapted for measuring one or more parameters associated with an industrial process or setting and sending a signal corresponding to the measurement via a cellular or satellite network;
an electronic controller adapted for receiving and processing signals from each of the plurality of sensor modules, generating one or more outputs in response to each signal, and transmitting the outputs;
software adapted for execution by the electronic controller and comprising instructions for processing each signal, and determining what actions to take in response to such signals, generating outputs to accomplish the desired actions, and transmitting the outputs to devices modules at the monitored process or setting, or at one more remote industrial processes or industrial settings;
a plurality of device modules adapted for receiving the outputs and taking an action in response thereto; and
at least one server for storing information regarding the process, serving the software in a form readable by the controller, and serving a web-based user portal; wherein the server and user portal are accessible from any location via the Internet or similar network;
wherein the electronic controller is in communication with the sensor modules and the device modules at least via the cellular or satellite network; and in communication with the server via the Internet or similar network
employing the system to detect a signal indicative of a potential problem or accident with safety, environmental, economic, or legal consequences; and
sending outputs via the system for one or more of the following:
activating one or more alarms or emergency evacuation systems for any personnel in the vicinity of the problem or accident;
logging useful data in connection to the problem or accident; said data comprising at least the signals corresponding to process measurements;
activating a local or remote system for recording audio and/or visual information related to the problem or accident;
switching on or off, or adjusting a setting in one or more aspects of the industrial process or a remote process; and
alerting one or more parties comprising an engineer, a manager, first responders, an executive, a regulatory authority, an emergency department, a health authority, an insurer, a legal advisor, or an investor about the problem;
providing access to the logged data to one or more of the parties alerted; and
continuing to log available data related to or about the problem or accident.

19. The method of claim 18 wherein the implemented system further comprises a personnel monitoring system comprising personal proximity devices in communication with data recording points distributed in an area of the industrial process or industrial setting, said personnel monitoring system adapted for communication with the controller, and for sending data therefrom to the controller for logging.

20. The method of claim 18 wherein a) the useful data further include the audio and/or visual information, or the data from the personnel monitoring system, or both; b) the logged data, or the audio and/or video information, or both can be accessed on real-time or near real-time by one or more of the alerted parties; and optionally c) wherein the method further comprises the step of permitting two or more parties to communicate with each other via means that facilitate two or more of the alerted parties communicating directly with each other while accessing the logged data on the cloud based device, or the audio and/or video information, or both, in real time or near real-time.
